(19) United States
(12) Patent Application Publication
(10) Pub. No.: US 2012/0147609 A1
(43) Pub. Date: Jun. 14, 2012

(54) LIGHTING COVERS

(76) Inventors: Jack Black, Elgin, SC (US); Kenneth E. Conley, Matthews, NC (US)

(21) Appl. No.: 13/314,913

(22) Filed: Dec. 8, 2011

Related U.S. Application Data
(60) Provisional application No. 61/422,013, filed on Dec. 10, 2010.

(51) Int. Cl. F21V 5/04

(52) U.S. Cl. 362/360

(57) ABSTRACT

Lighting covers are disclosed. An example lighting fixture cover includes a sheet of material comprising a plurality of lenticules. A focal plane of the lenticules to be at a distance from a light source to enable light rays that travel from the light source through the lenticules to be directed in more than two directions.

### RELATED APPLICATION

This patent claims priority to U.S. Provisional Application No. 61/422,013 filed Dec. 10, 2010, which is hereby incorporated herein by reference in its entirety.

### FIELD OF THE DISCLOSURE

This patent relates generally to covers and, more specifically, to lighting covers.

### BACKGROUND

Lighting covers are used in lighting fixtures to cover light sources. Some known lighting covers include prismatic patterns. To reduce the observance of ‘hot spots’ surrounding the light source when the light source is lit, lighting covers having prismatic patterns may include fillers and/or pigments. However, the use of fillers and/or pigments also decreases light transmission efficiency.

### BRIEF DESCRIPTION OF THE DRAWINGS

FIG. 1 depicts an example ray tracing of light rays through a lighting cover having a prismatic pattern.

FIG. 2 depicts an example lighting cover having an example lenticular pattern.

FIG. 3 depicts an example lighting cover having an example lenticular pattern.

FIG. 4 depicts an example ray tracing of light rays through an example lighting cover having an example lenticular pattern.

FIG. 5 depicts another example ray tracing of light rays through an example lighting cover having an example lenticular pattern.

FIG. 6 depicts a portion of an example lighting cover having an example lenticular pattern.

FIG. 7 depicts light sources being covered by different example lighting covers having example lenticular patterns.

FIG. 8 depicts light sources being covered by different example lighting covers having example lenticular patterns.

FIG. 9 depicts light sources being covered by an example lighting cover having an example lenticular pattern.

FIG. 10 depicts light sources being covered by an example lighting cover having an example lenticular pattern.

FIG. 11 depicts light sources being covered by an example lighting cover having an example lenticular pattern.

FIG. 12 depicts an example ray tracing of light rays through an example lighting cover having an example lenticular pattern.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples. Although the following discloses example systems and components that may be produced and/or fabricated using plastic, it should be noted that such systems are merely illustrative and should not be considered as limiting. Additionally, while some of the figures include dimensions, such dimensions are merely included for purposes of example and should not, therefore, be considered as limiting.

The examples described relate to lighting covers that are highly efficient (e.g., 92% efficient), have light dispersion/diffusion properties as well as obscurity properties. More specifically, the examples described relate to lighting covers having a pattern(s) that causes at least some light rays passing therethrough to cross at a relatively high density and/or to scatter. Crossing and/or scattering the light rays enables light dispersion and/or obscurity properties and, thus, a light source (e.g., light bulbs) being covered to be less apparent. Additionally or alternatively, the obscurity properties may substantially prevent ‘hot spots’ surrounding the light source from being observed and/or occurring when the light source is lit. The light source may be any suitable light source such as a florescent light bulb (e.g., a T5 florescent bulb) or a LED light bulb, for example.

In some example, the pattern that enables crossing of at least some light rays at a relatively high density and/or scattering may be a lenticular pattern embossed on to an extruded flat sheet of material. The lenticular pattern may have a focal plane to be positioned at a distance from the light source being covered. A distance between the focal plane and the light source ensures that at least some light rays being emitted from the light source will cross and/or scatter as and/or after they pass through the lenticular pattern and/or past the focal plane causing the light source to be substantially hidden. In some examples, the focal plane may be positioned within the lighting cover or on a surface of the lighting cover.

The lenticular pattern may be any suitable lenticular pattern that provides sufficient obscurity properties to substantially hide a light source being covered and/or to substantially prevent ‘hot spots’ from being observed where the light source is positioned. For example, the lenticular pattern may include elongate lenticules extending in one or more directions, lenticules that cross and/or are misaligned and/or lenticules forming a dot like pattern. The dot like pattern may be closely packed and/or have a relatively high frequency, for example.

The lenticules of the lenticular pattern may have any number of lines per inch, may have a narrow viewing angle or a wide viewing angle and/or may have a relatively large arc angle or a relatively small arc angle. The example lenticular pattern may have about 10 lines per inch (lpi) and 200 lpi. The example lenticular pattern may have a viewing angle of between about 9-degrees and 55-degrees. The example lenticular pattern may have an arc angle of between about 50-degrees and 180-degrees. In some examples, a wide viewing angle may cause more light ray crossing and/or scattering than a narrow viewing angle and, thus, more light dispersion/diffusion. A wide viewing angle may be between about 35-degrees and 55-degrees, for example. In some examples, a relatively high lpi such as equal to or greater than 50 lpi may cause more obscurity properties than a relatively low lpi such as 10 lpi. In some examples, a relatively large arc angle such as equal to or greater than 110-degrees may cause more light ray crossing and/or scattering than a relatively small arc angle.

In some example, the lenticular pattern may include elongate lenticules extending in a single direction such as parallel to a light source or perpendicular to a light source. When an example lighting cover is positioned adjacent to a light source, the lighting cover may be positioned such that the lenticules face the light source or such that the lenticules face away from the light source.

In other examples, the lenticular pattern may include first elongate lenticules extending in a first direction and second elongate lenticules extending in a second direction. The first direction may be parallel to the light source and the second direction may be perpendicular to the light source such that at least some of the first lenticules cross the second lenticules at respective dots. The first lenticules may be positioned at any suitable angle relative to the second lenticules such as 30-degrees, 40-degrees, 90-degrees, etc. The first lenticules may be on the same side or a different side of the lighting cover as the second lenticules. If the first and second lenticules are on the same side of a lighting cover, when the example lighting cover is positioned adjacent to a light source, the lighting cover may be positioned such that the lenticules face the light source or such that the lenticules face away from the light source.

While the above examples describe up to two elongate lenticules being embossed on the example lighting covers, the example lighting covers may include one or more elongate lenticules on a first side of the lighting cover extending in different directions and/or one or more elongate lenticules on a second side of the lighting cover extending in different directions. Additionally or alternatively, the example lighting covers may include more than one sheet having a lenticular pattern(s) on either one or both sides. The sheets may be coupled together or may be positioned adjacent one another in the light source without being coupled, for example.

The example lighting covers may be sheets made of any suitable material(s) that may include an additive, a filler(s) and/or a pigment(s). In some example, the material may be a plastic material such as a clear resin, Poly(methyl methacrylate) or acrylic resin having a thickness of approximately 0.050 inches or greater; however, the material may have a thickness less than 0.050 inches. The additive may be DURAfrost®.

In some examples, sheets having a lenticular pattern of between about 50 lpi and 90 lpi may have a thickness great enough to prevent sagging when the lighting cover is positioned in a lighting fixture. In other examples, sheets having a lenticular pattern of between about 90 lpi and 200 lpi may be extruded to be relatively thin. These relatively thin sheets may be coupled (e.g., laminated) to another sheet to substantially prevent sagging when the lighting cover is positioned in a lighting fixture. The other sheet may be a clear sheet and may have a thickness greater than the sheet having the lenticular pattern, for example.

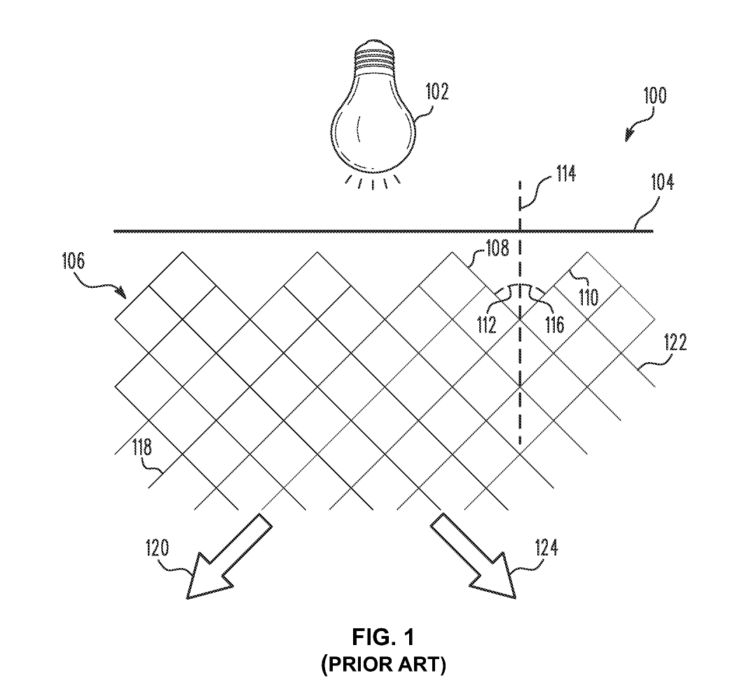

FIG. 1 depicts a ray tracing 100 of light from a light source 102 traveling through a known lighting cover 104. The known lighting cover 104 includes a prismatic pattern 106 having first surfaces 108 and second surfaces 110. The first surfaces 108 are positioned at a first angle 112 relative to an axis 114 and the second surfaces 110 are positioned at a second angle 116 relative to the axis 114 opposite the first angle 112.

As light rays emitted from the light source 102 travel toward and/or through the lighting cover 104, light rays 118 engaging the first surfaces 108 are all directed in a first direction generally represented by arrow 120 and light rays 122 engaging the second surfaces 110 are all directed in a second direction generally represented by arrow 124. Light rays traveling through the lighting cover 104 are only directed in two directions 120 and 124 and, thus, cross at a relatively low density. Light rays crossing at a relatively low density causes the light source 102 being covered by the lighting cover 104 to be clearly observable through the lighting cover 104 and/or to not be substantially obscured such that the light source 102 appears the same size through the lighting cover 104 as the light source 102 actually is. Additionally or alternatively, light rays crossing at a relatively low density causes the observance of ‘hot spots’ surrounding the light source 102 though the known lighting cover 104.

In an attempt to reduce the ability to observe the light source 102 through the lighting cover 104 and/or to reduce the observance of ‘hot spots’ through the lighting cover 104, pigments and/or fillers may be added to the lighting cover 104. However, such pigments and/or fillers also reduce the light transmission efficiency of the light source 102.

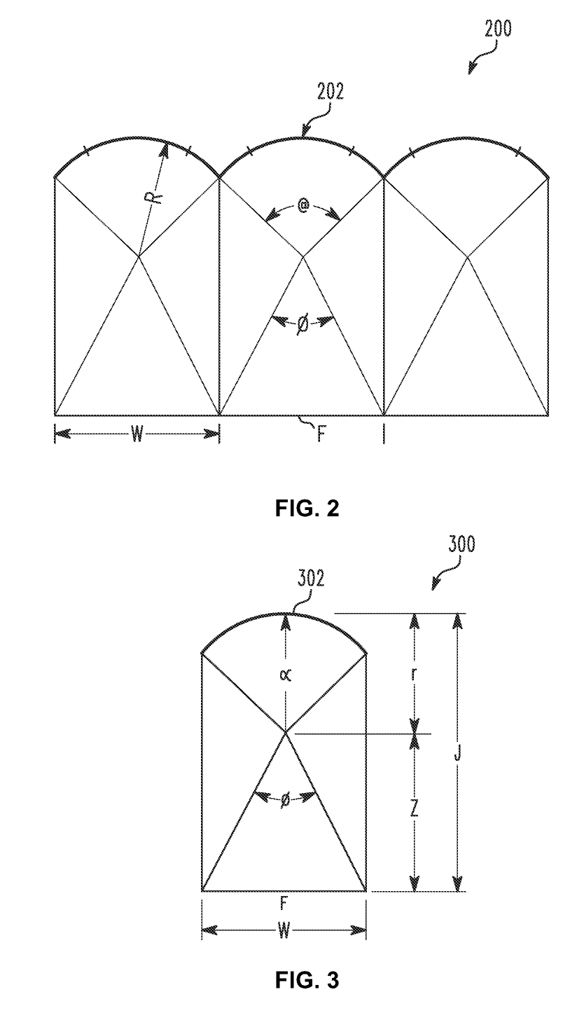

FIG. 2 depicts an example lighting cover 200 having an example lenticular pattern 202 that may be used to implement the examples described herein. The lighting cover 200 and/or the lenticular pattern 202 includes a lens radius represented by R, an arc angle represented by @ and an acceptant angle or viewing angle represented by . Additionally, the lighting cover 200 and/or the lenticular pattern 202 includes a lens width represented by W and a focal plane represented by F. In some examples, the position of the focal plane F relative to the lighting cover 200 may represent the optimum thickness. In some examples, the refractive index of the lighting cover 200 may be 1.56 if the lighting cover 200 includes a clear amorphous thermoplastic such as PETG and/or Polyethylene terephthalate (PET).

FIG. 3 depicts an example lighting cover 300 having an example lenticular pattern 302 that may be used to implement the examples described herein.

In some examples, the arc angle, α, may be determined using Equation 1 below where W represents the lenticule width, J represents the total thickness of the lighting cover 300, r represents the radius of curvature, Z represents the focal length, represents the acceptant angle or viewing angle and n represents the refractive index.

$$∝ = 2 [ sin \frac{( w / 2 )}{J ( r / z )} ] = 2 [ sin \frac{∅}{2} / Cos \frac{∅}{2} \frac{1 - \frac{1}{r}}{( 1 / n )} ] \qquad Equation 1$$

Additionally or alternatively, the arc angle, α, may be determined using Equation 2 below where W represents the lenticule width and r represents the radius of curvature.

$$∝ = 2 ARC SIN \frac{W}{2 r} \qquad Equation 2$$

The acceptant angle or the viewing angle, , may be determined using Equation 3 below where W represents the lenticule width, J represents the total thickness of the lighting cover 300 and η represents the refractive index.

$$= 2 ARCTAN \frac{W}{( 2 J / n )} \qquad Equation 3$$

The lenticule depth, Q, may be determined using Equation 4 below where r represents the radius of curvature and a represents the arc angle.

$$Q = r - [ ( cos \frac{∝}{2} ) r ] \qquad Equation 4$$

Additionally or alternatively, the lenticule depth, Q, may be determined using Equation 5 below where η represents the refractive index, represents the acceptant angle or viewing angle and J represents the total thickness of the lighting cover 300.

$$Q = 2 ARC SIN \frac{( 1 / n ) TAN ( ∅ / 2 )}{1 - ( \text{?} / n )} \\ \text{?} \text{?} \\ \text{?} \text{indicates text missing or illegible when filed} \qquad Equation 5$$

Additionally or alternatively, the lenticule depth, Q, may be determined using Equation 6 below where α represents the arc angle and η represents the refractive index.

$$Q = \frac{1 - Cos ( ∝ / 2 )}{1 / ( 1 - \frac{1}{n} )} \qquad Equation 6$$

The radius of curvature, r, may be determined using Equation 7 below where J represents the total thickness of the lighting cover 300 and η represents the refractive index.

$$r = J - \frac{J}{n} \qquad Equation 7$$

Additionally or alternatively, the radius of curvature, r, may be determined using Equation 8 below where η represents the refractive index, represents the acceptant angle or viewing angle and J represents the total thickness of the lighting cover 300.

$$r = cos \frac{∅}{2} \times \frac{1 - {( 1 / n )}^{′}}{( 1 \vert / n )} \\ \text{?} \\ \text{?} \text{indicates text missing or illegible when filed} \qquad Equation 8$$

The focal length, Z, may be determined using Equation 9 below where J represents the total thickness of the lighting cover 300 and η represents the refractive index.

$$Z = \frac{J}{n} \qquad Equation 9$$

Additionally or alternatively, the focal length, Z, may be determined using Equation 10 below where represents the acceptant angle or viewing angle.

$$Z = Co \vert s \frac{∅}{2} \\ \text{?} \text{?} \\ \text{?} \text{indicates text missing or illegible when filed} \qquad Equation 10$$

The lenticular width, W, may be determined using Equation 11 below where J represents the total thickness of the lighting cover 300, represents the acceptant angle or viewing angle and η represents the refractive index.

$$W = \frac{2 J}{\text{?}} \times TAN \frac{∅}{2} \\ \text{?} \text{indicates text missing or illegible when filed} \qquad Equation 11$$

Additionally or alternatively, the lenticular width, W, may be determined using Equation 12 below where represents the acceptant angle or viewing angle.

$$W = 2 SiN \frac{∅}{2} \qquad Equation 12$$

The number of lines per inch may be determined using equation 13 below where W represents the lenticular width.

$$LINES PER IN . = \frac{25.4}{W} \qquad Equation 13$$

Equation 14 below represents some relationships between the above identified variables.

$$\text{?} / \text{?} = \frac{Z}{W} OR \frac{\text{?}}{W} OR \frac{1}{2 TAN ( ∅ / 2 )} OR \frac{2 SIN ( ∅ / 2 )}{Cos ( ∅ / 2 )} \\ \text{?} \text{indicates text missing or illegible when filed} \qquad Equation 14$$

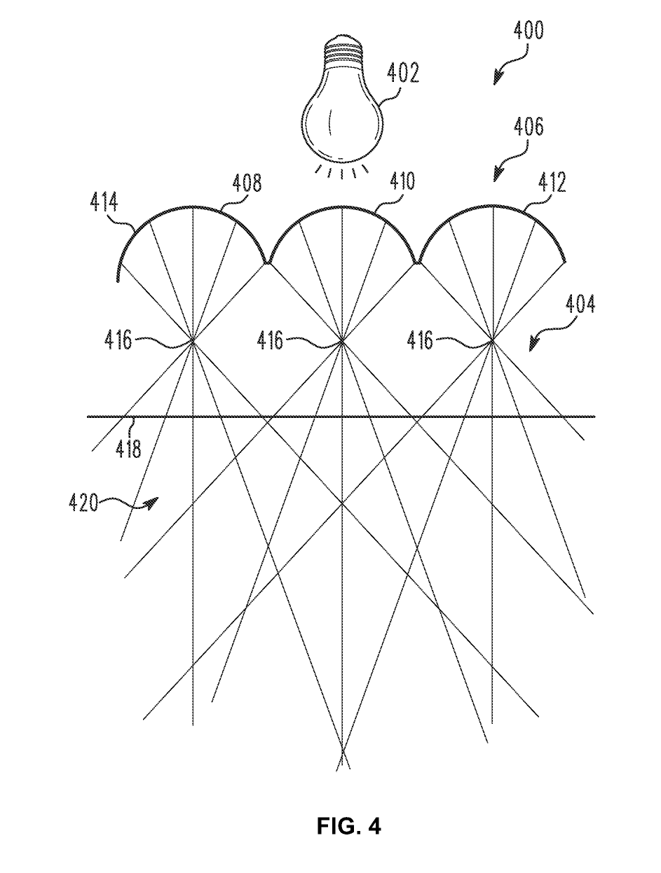

FIG. 4 depicts a ray tracing 400 of light from a light source 402 traveling through an example lighting cover 404. The lighting cover 404 includes an example lenticular pattern 406. The lenticular pattern 406 may have a viewing angle of approximately 52-degrees and an arc angle of approximately 150-degrees. Each lenticule (e.g., elongated lenticule) 408, 410 and 412 of the lenticular pattern 406 includes a surface 414 that directs light rays passing therethrough toward a point 416 adjacent the respective lenticule 408-412. Thus, instead of directing light rays in just two directions as with the known lighting cover 104 having the prismatic pattern 106, the example lighting cover 404 having the lenticular pattern 406 directs light rays in numerous directions (e.g., greater than two directions) enabling light rays passing through the lighting cover 404 to be scattered once the light rays pass a focal plane 418 and into an area of diffusion 420. Once the light rays pass the focal plane 418, the light rays begin to cross and/or scatter. Additionally, the example lighting cover 404 having the lenticular pattern 406 directs light rays in numerous directions such that the light rays cross at a relatively high density. Because the light source 402 is at a distance from the focal plane 418, the light source 402 and/or any object covered by the lighting cover 404 may be substantially hidden and/or substantially obscured due to dense light ray crossing and/or scattering past the focal plane 418.

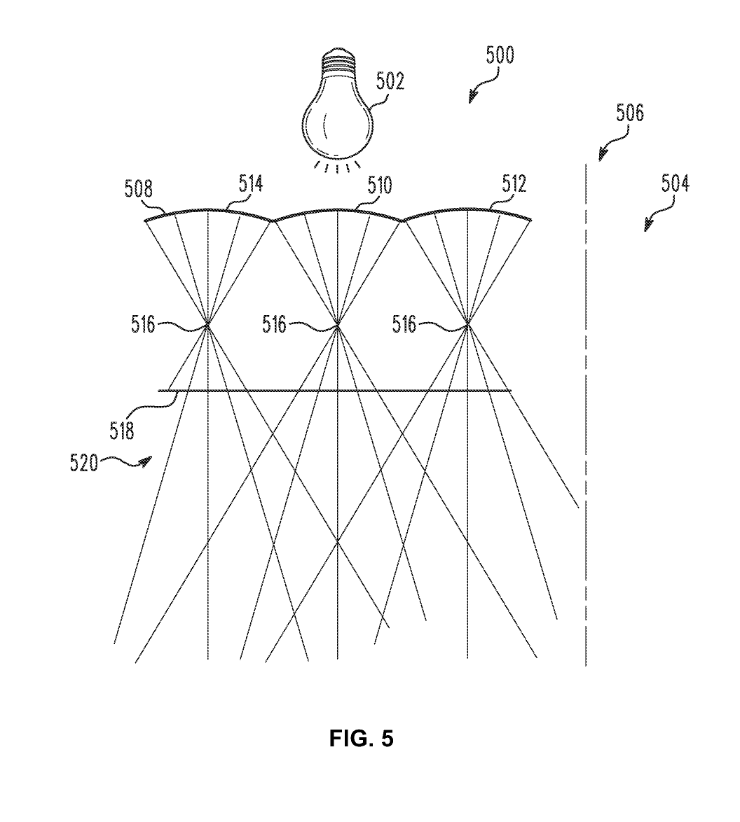

FIG. 5 depicts a ray tracing 500 of light from a light source 502 traveling through an example lighting cover 504. The lighting cover 504 includes an example lenticular pattern 506. The lenticular pattern 506 may have a viewing angle of approximately 26-degrees and an arc angle of approximately 50-degrees. Because the viewing angle and/or the arc angle of the example lighting cover 504 is less than the viewing angle and/or the arc angle of the lighting cover 404, less ray crossing and/or scattering may occur when the lighting cover 504 is used than when the lighting cover 404 is used.

Each lenticule (e.g., elongated lenticule) 508, 510 and 512 of the lenticular pattern 506 includes a surface 514 that directs light rays passing therethrough toward a point 516 adjacent the respective lenticule 508-512. As with the example lighting cover 404, the example lighting cover 504 having the lenticular pattern 506 directs light rays in numerous directions (e.g., greater than two directions) enabling light rays passing through the lighting cover 504 to be scattered once the light rays pass a focal plane 518 and into an area of diffusion 520. Additionally, the example lighting cover 504 having the lenticular pattern 506 directs light rays in numerous directions such that the light rays cross at a relatively high density. Because the light source 502 is at a distance from the focal plane 518, the light source 502 and/or any object covered by the lighting cover 504 may be substantially hidden and/or substantially obscured due to dense light ray crossing and/or scattering past the focal plane 518.

FIG. 6 depicts an example lighting cover 600 having an example lenticular pattern 602. The lighting cover 600 may be made of an acrylic resin (PMMA) that has been extruded into a flat sheet and then embossed with the lenticular pattern of 60 lpi.

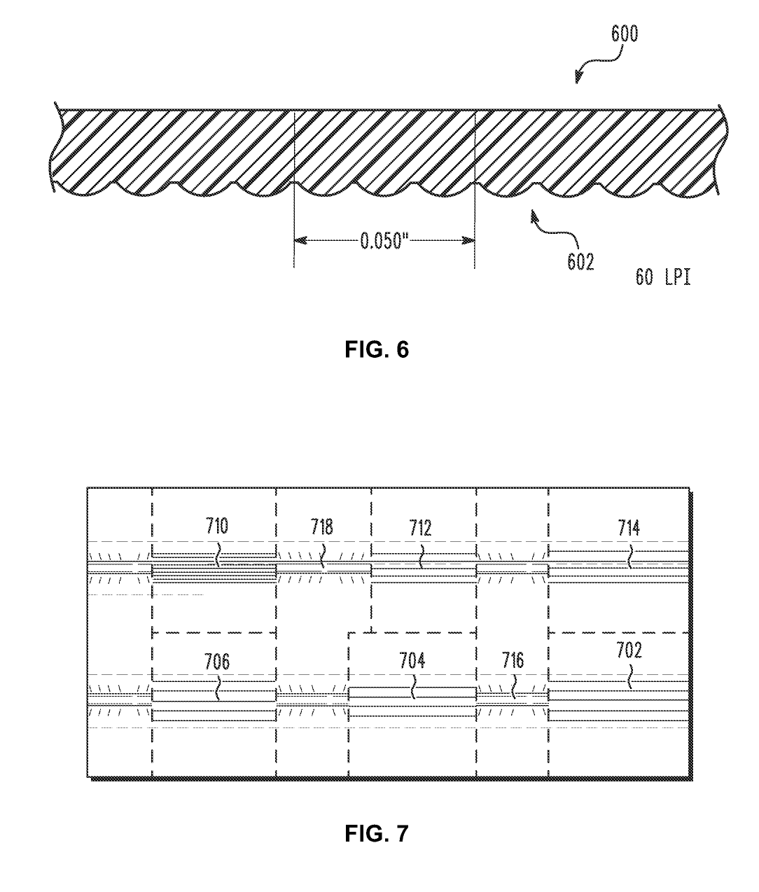

FIG. 7 depicts example sheets 702-714 respectively covering a first light bulb 716 and a second light bulb 718. Sheet 702 represents results in which two sheets having a lenticular pattern of 10 lpi are crossed at 90-degrees to cover the first light bulb 716. Sheet 704 represents results in which two sheets having a lenticular pattern of 15 lpi are crossed at 90-degrees to cover the first light bulb 716. Sheet 706 represents results in which two sheets having a lenticular pattern of 20 lpi are crossed at 90-degrees to cover the first light bulb 716.

Sheet 710 represents results in which two sheets having a lenticular pattern of 20 3-D lpi are crossed at 90-degrees to cover the second light bulb 718. The sheet 710 has a lenticular pattern having the same pitch as the lenticular pattern of the sheet 706, but has a narrower viewing angle such as 26-degrees as compared to 49-degrees. Sheet 712 represents results in which two sheets having a lenticular pattern of 40 3-D lpi and a relatively narrow viewing angle are crossed at 90-degrees to cover the second light bulb 718. Sheet 714 represents results in which two sheets having a lenticular pattern of 60 3-D lpi and a relatively narrow viewing angle are crossed at 90-degrees to cover the second light bulb 718. Visually comparing the sheets 702-706 to sheets 710-714 illustrates that a wider viewing angle may provide a higher degree of hiding power to hide the light bulbs 716 and 718 as compared to when the sheets include a narrower viewing angle.

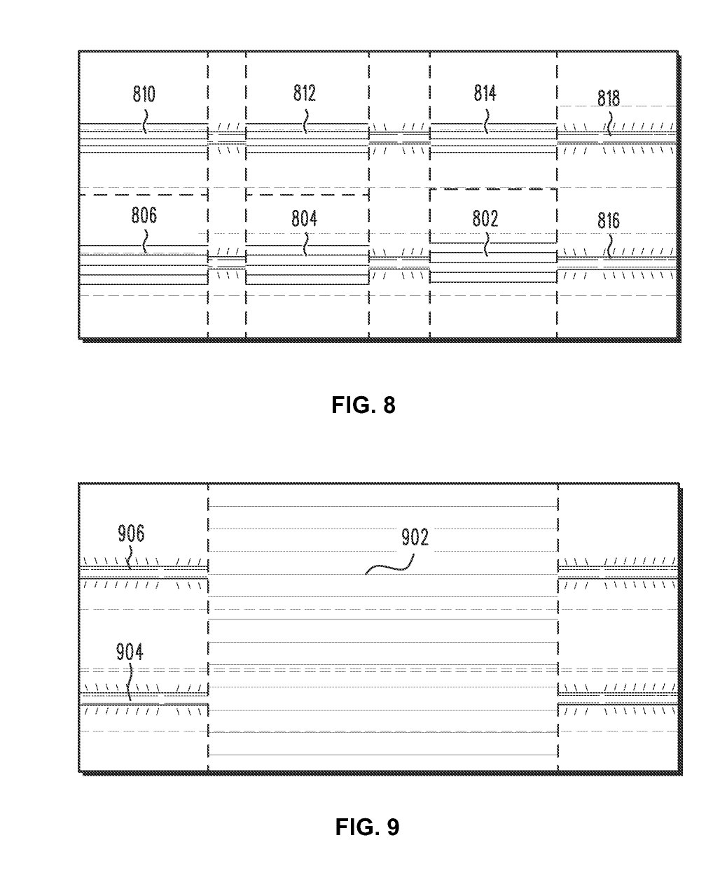

FIG. 8 depicts example sheets 802-814 respectively covering a first light bulb 816 and a second light bulb 818. Sheet 802 represents results in which a single sheet having a lenticular pattern of 10 lpi covers the first light bulb 716. Sheet 804 represents results in which a single sheets having a lenticular pattern of 15 lpi covers the first light bulb 816. Sheet 806 represents results in which a single sheet having a lenticular pattern of 20 lpi covers the first light bulb 816.

Sheet 810 represents results in which a single sheet having a lenticular pattern of 20 3-D lpi covers the second light bulb 8. The sheet 810 has a lenticular pattern having the same pitch as the lenticular pattern of sheet 806, but has a narrower viewing angle such as 26-degrees as compared to 49-degrees. Sheet 812 represents results in which a single sheet having a lenticular pattern of 40 3-D lpi and a relatively narrow viewing angle covers the second light bulb 718. Sheet 714 represents results in which a single sheet having a lenticular pattern of 60 3-D lpi and a relatively narrow viewing angle covers the second light bulb 718. Visually comparing the sheets 802-806 to sheets 810-814 illustrates that a wider viewing angle may provide a higher degree of hiding power to hide the light bulbs 816 and 818 as compared to using a narrower viewing angle. Additionally, visually comparing the sheets 802-806 to sheets 810-814 illustrates that a coarser lenticular pattern (e.g., 10 lpi) may provide a lesser degree of hiding power to hide the light bulbs 816 and 818 as compared to a less coarse lenticular pattern (e.g., 60 lpi). In some example, a lenticular pattern having greater than or equal to 50 lpi may substantially completely hide the light bulbs 816 and 818.

FIG. 9 depicts an example sheet 902 covering light bulbs 904 and 906. Sheet 902 represents results in which two sheets having a lenticular pattern of 15 lpi are crossed at 90-degrees to cover the light bulbs 904 and 906.

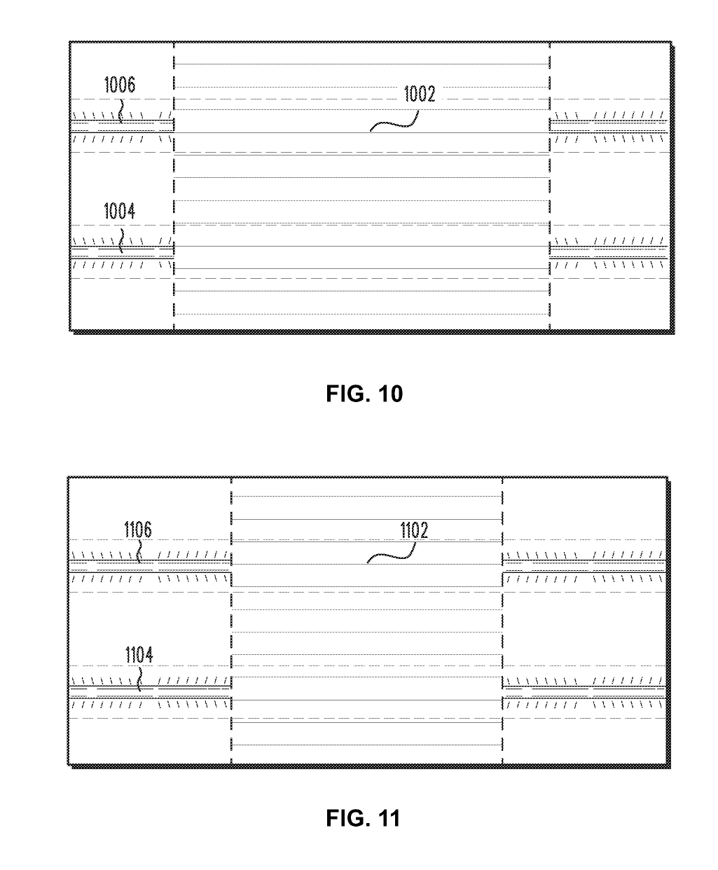

FIG. 10 depicts an example sheet 1002 covering light bulbs 1004 and 1006. Sheet 1002 represents results in which two sheets having a lenticular pattern of 20 lpi are crossed at 90-degrees to cover the light bulbs 904 and 906.

FIG. 11 depicts an example sheet 1102 covering light bulbs 1104 and 1106. Sheet 1102 represents results in which two sheets having a lenticular pattern of 20 lpi and a relatively wide viewing angle are crossed at 90-degrees to cover the light bulbs 1104 and 1106. A visual comparison between the sheet 1002 of FIG. 10 and the sheet 1102 of FIG. 11 illustrates that sheets having a wide viewing angle may be more desirable to hide the respective light bulbs being covered by the sheets 1002 and/or 1102, and/or to provide greater obscurity, diffusion and/or dispersion.

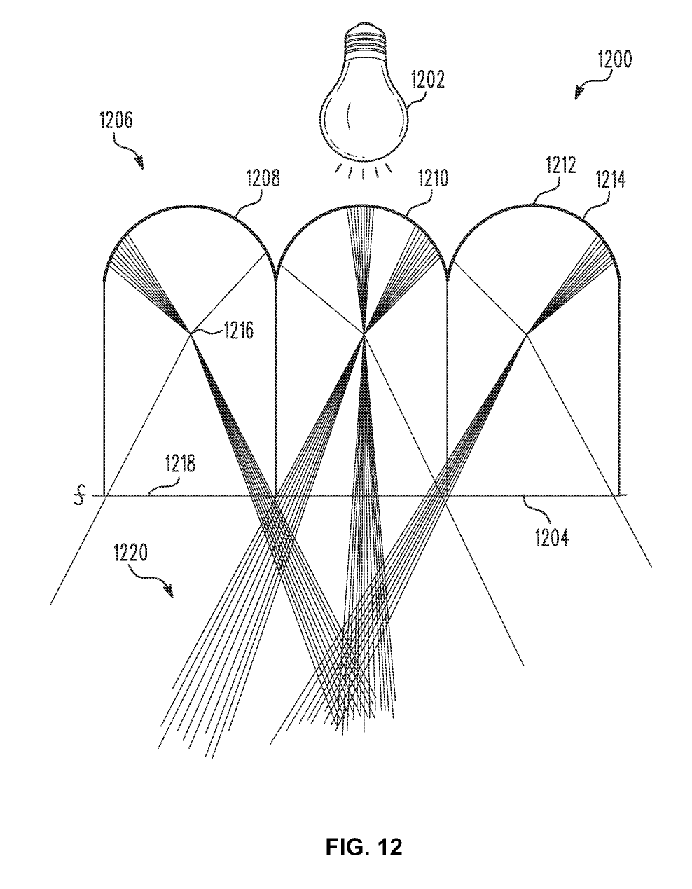

FIG. 12 depicts a ray tracing 1200 of light from a light source 1202 traveling through an example lighting cover 1204. The lighting cover 1204 includes an example lenticular pattern 1206.

Each lenticule (e.g., elongated lenticule) 1208, 1210 and 1212 of the lenticular pattern 1206 includes a surface 1214 that directs light rays passing therethrough toward a point 1216 adjacent the respective lenticule 1208-1212. As with the example lighting cover 404, the example lighting cover 1204 having the lenticular pattern 1206 directs light rays in numerous directions (e.g., greater than two directions) enabling light rays passing through the lighting cover 1204 to be scattered once the light rays pass a focal plane 1218 and into an area of diffusion 1220. Additionally, the example lighting cover 1204 having the lenticular pattern 1206 directs light rays in numerous directions such that the light rays cross at a relatively high density. Because the light source 1202 is at a distance from the focal plane 1218, the light source 1202 and/or any object covered by the lighting cover 1204 may be substantially hidden and/or substantially obscured due to dense light ray crossing and/or scattering past the focal plane 1218.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A lighting fixture cover, comprising:
a sheet of material comprising a plurality of lenticules, a focal plane of the lenticules to be at a distance from a light source to enable light rays that travel from the light source through the lenticules to be directed in more than two directions.

2. The lighting fixture cover of claim 1, wherein the lenticules are embossed on to the sheet of material.

3. The lighting fixture cover of claim 1, wherein the lenticules comprise a lenticular pattern.

4. The lighting fixture cover of claim 3, wherein the lenticular pattern comprises between about 10 lines per inch and 200 lines per inch.

5. The lighting fixture cover of claim 3, wherein the lenticular pattern comprises approximately or greater than 50 lines per inch.

6. The lighting fixture cover of claim 3, wherein the lenticular pattern comprises between about 50 lines per inch and 90 lines per inch.

7. The lighting fixture cover of claim 1, wherein the lenticules comprise a viewing angle of between about 9 degrees and 55 degrees.

8. The lighting fixture cover of claim 1, wherein the lenticules comprise a viewing angle of between about 35 degrees and 55 degrees.

9. The lighting fixture cover of claim 1, wherein the lenticules comprise a arc angle of between about 50 degrees and 180 degrees.

10. The lighting fixture cover of claim 1, wherein the lenticules comprise an arc angle of approximately or greater than 110 degrees.

11. The lighting fixture cover of claim 3, wherein the lenticular pattern comprises an arc angle of approximately or greater than 50 degrees.

12. The lighting fixture cover of claim 3, wherein the lenticular pattern comprises a 3 dimensional lenticular pattern.

13. The lighting fixture cover of claim 1, wherein the lenticules are to be positioned in a direction substantially parallel to or perpendicular to the light source.

14. The lighting fixture cover of claim 1, wherein the lenticules comprise first lenticules positioned in a first direction and second lenticules positioned in a second direction different than the first direction.

15. The lighting fixture cover of claim 14, wherein the first lenticules are on a first side of the sheet and the second lenticules are on a second side of the sheet.

16. The lighting fixture cover of claim 1, further comprising a second sheet of material to be positioned adjacent or coupled to the sheet.

17. The lighting fixture cover of claim 16, wherein the second sheet comprises a plurality of lenticules.

18. The lighting fixture cover of claim 16, wherein the second sheet comprises a thickness greater than a thickness of the sheet.

19. The lighting fixture cover of claim 1, wherein the sheet comprises one or more of a filler or a pigment.

20. A lighting fixture cover, comprising:
a sheet of material comprising a pattern that enables light rays that travel from a light source through the pattern to be directed in more than two directions.

21. The lighting fixture cover of claim 20, wherein the pattern comprise a plurality of lenticules.

22. The lighting fixture cover of claim 21, wherein a focal plane of the lenticules is to be at a distance from the light source.
